(19) United States
(12) Patent Application Publication
(10) Pub. No.: US 2023/0187913 A1
(43) Pub. Date: Jun. 15, 2023

(54) System for Temporarily Mounting Overhead Equipment on a Utility Pole Without Damaging the Pole and Assembly for Use Therein

(71) Applicant: DTE Electric Company, Detroit, MI (US)

(72) Inventors: Thomas James Grant, JR., Port Huron, MI (US); Roy Landus Oakley, Rockwood, MI (US); George Gary Schomberger, Williamston, MI (US); Shawn Dwight Hirth, Northville, MI (US); John Patrick Connors, Brighton, MI (US)

(73) Assignee: DTE Electric Company, Detroit, MI (US)

(21) Appl. No.: 17/547,677

(22) Filed: Dec. 10, 2021

(51) Int. Cl. H02G 1/04; F16B 2/06

(52) U.S. Cl. CPC H02G 1/04; F16B 2/06

(57) ABSTRACT

A system for temporarily mounting overhead equipment on a utility pole without damaging the pole and at least one assembly for use therein are provided. Each assembly includes an enclosure having a first and second opposed multilayered parts. Each of the parts has a rigid substrate layer underlying a compressible, gripping layer. The substrate layers are hingedly secured to one another by a hinge area which allows the parts to temporarily and repeatedly open and close in a closed configuration. The gripping layers of the parts are configured to apply a clamping force at opposite circumferential surfaces of the pole in the closed configuration. The assembly also includes a support member fixedly secured to one of the substrate layers and configured to support the overhead equipment. The clamping force is sufficient to maintain the assembly and the supported overhead equipment at a desired overhead location on the pole.

### TECHNICAL FIELD

At least one embodiment of the present invention generally relates to systems and assemblies for temporarily mounting overhead equipment on utility poles and, in particular, to such systems and assemblies which do not result in damage to the poles.

### OVERVIEW

Utility poles used to support overhead electrical power lines and associated components (transformers, street-lights and the like) or other public utilities such as cable and fiber optic cable must be replaced periodically, either as part of a maintenance program or in response to damage from storms or vehicles. Replacement of poles is asset intensive, requiring specialized equipment including truck mounted cranes and bucket trucks even to replace a single pole damaged by a vehicular collision. However, demand for such assets, for example, to effect repairs after a storm, may strain the capabilities of even the most well-equipped utility company, leaving some customers without power while they wait their turn for the equipment to fix a downed pole. Additionally, if any excavation is required for even a temporary repair, permission to dig must be cleared with a utility or other clearing house to avoid damage to underground infrastructure such as gas or telephone lines. This lengthens the time required to effect repair. Furthermore, replacing utility poles in urban areas may require double the amount of equipment be used because space is limited and thus a replacement pole must go into the same hole as the original pole. When space is limited a first crane is needed to remove the original pole and hold it so that it remains in the line while a second crane positions the replacement pole in the hole. The power lines are then transferred from the original pole to the replacement pole.

As described in U.S. Pat. No. 10,626,632, FIGS. 1-3 show a prior art embodiment of a mobile utility pole unit 10 for temporary support of overhead equipment such as crossarm members 40 which, in turn, support electrical wires or lines 12 (also referred to as “circuits”). A trailer 14 comprising a base 16 is mounted on a plurality of wheels 18. A hitch mechanism 20 is attached to the base 16 to permit the trailer 14 to be towed behind a vehicle (not shown). A boom assembly 22 is mounted on the base 16 via a pedestal 23. The boom assembly 22 has a terminal end 24 which is pivotally mounted on the pedestal 23 for pivoting motion about an axis 26. A first actuator 28 acts between the pedestal 23 and the boom assembly 22 for pivoting it about the axis 26. The boom assembly 22 also has a free end 30 on which a temporary cylindrical fiberglass utility pole 32 is mounted. The utility pole 32 comprises a column 34 having a first end 36 attached to the free end 30 of the boom assembly 22. A second end 38 of the column 34 is oppositely disposed from the first end 36. At least a first, strap-mounted, fiberglass crossarm member 40 is attached to the utility pole 32 proximate to the second end 38 of the column 34 (see also FIG. 4 herein). Additional crossarm members 40 may also be attached to the column 34 in spaced relation to one another, the crossarm members 40 carrying different circuits when present.

FIG. 4 shows a prior art assembly including a nylon ratchet strap 41 which connects the crossarm 40 to the pole 32. The assembly also includes a U-shaped support bracket 43 shown digging into (i.e. damaging) the pole 32.

Roller assemblies 41 support the wires 12. Each roller assembly 41 comprises a bracket with a pivoting latch which is movable to an open position to permit a wire 12 to be positioned on its rollers. Each roller assembly 41 is attached to its crossarm member 40 by an insulator. The roller assemblies 41 minimize friction between their brackets and the wires 12 when the utility pole 32 is deployed. The utility pole 32 is made of a fiberglass pultrusion. In another embodiment, the pole may be made of wood and advantageously cut from a standard wooden utility pole. This provides for commonality of components and hardware with those already in use by the utility company.

The boom assembly 22 comprises a plurality of boom segments 42 pivotally attached to one another. The boom assembly 22 comprises: 1) a terminal boom segment 44 which includes the terminal end 24 of the boom assembly 22; 2) a free boom segment 46 which includes the free end 30 of the boom assembly 22 to which the utility pole 32 is attached; and 3) an intermediate boom segment 48. One end of the intermediate boom segment 48 is pivotally attached to the terminal boom segment 44 for pivoting motion about an axis; an opposite end of the intermediate boom segment 48 is pivotally attached to the free boom segment 46 for pivoting motion about an axis 52.

A plurality of actuators extend between the boom segments to effect their pivoting motion. An actuator 56 acts between the terminal boom segment 44 and the intermediate boom segment 48. An actuator 58 acts between the intermediate boom segment 48 and the free boom segment 46. In an example embodiment, the actuators 28, 56 and 58 are hydraulic actuators. Other forms of actuators, such as electro-mechanical actuators, are also feasible.

The actuators 28, 56 and 58 operate between gusset plates attached to the boom segments. The attachments between the actuators and the gusset plates are pin joints which permit relative rotation between each actuator and the gussets to which it is attached. The actuator 28 operates between the pedestal 23 and a gusset plate 27 affixed to the terminal boom segment 44. The actuator 56 acts between a gusset plate 29 affixed to the terminal boom segment 44 and a gusset plate 31 is affixed to the intermediate boom segment 48 and is also pivotally attached to the terminal boom segment 44 at a pivot axis. The actuator 58 acts between a gusset plate 33 affixed to the intermediate boom segment 48 and a gusset plate 35 which is pivotally attached to both the intermediate boom segment 48 and the free boom segment 46 via respective pivoting links 37 and 39. Use of the various gusset plates simplifies the attachment of the actuators to the booms and provides mechanical advantage and/or a desired angular boom rotation for a given actuator stroke. The gusset plates may be further designed to allow the same actuator to be used throughout the boom assembly 22.

Another actuator 60 acts between the utility pole 32 and the free boom segment 46. The actuator 60 effects rotation of the utility pole 32 about its longitudinal axis 62 and may also comprise a hydraulic actuator, for example, a slewing ring and hydraulic rotor. In an alternate embodiment, a worm gear or an electrical motor may be used to effect rotation of the pole 32. In one embodiment, the actuator is capable of rotating the pole 32 at least through a full 360 degrees about the axis 62. The rotation may be infinitely adjustable. Advantageously, the actuator 60 may be self-limiting through the use of a relief valve, which limits the torque which can be applied to rotate the pole 32. The limitation helps prevent damage, for example, to power lines that might be attached to the pole 32. A clamp 64 is used to hold the utility pole 32 to the free end 30 of the free boom segment 46, the actuator 60 being positioned between the free end 30 and the clamp 64. Use of the clamp 64 permits the utility pole 32 to be replaced if needed. The trailer 14 may also be configured to store replacement utility poles 32.

The various hydraulic actuators 28, 56, 58 and 60 are actuated by a hydraulic pump 66 driven by a motor 68. Both the pump 66 and the motor 68 may be mounted on the trailer 14, for example, within the pedestal 23 (see also FIG. 3). The motor 68 may be an electrical motor powered by batteries 67 located in a battery compartment 69 mounted on the trailer 14. A battery charger 71 for controlling the voltage and current applied to recharge the batteries 67 is also positioned within the battery compartment 69. The battery charger 71 may be connected to a generator 73 powered by an internal combustion engine. Additionally, solar panels may be mounted on the trailer 14 (atop the battery compartment 69 in this example) to assist in battery charging. Other power options include direct electrical service power or power from another vehicle or a towed compressor or generator and connectable to the battery charger 71 for recharging the batteries 67 or directly to the electrical motor 68 for operating the mobile pole unit 10. The mobile utility pole unit 10 or trailer may also have an electrical system which powers electrical components such as lights and a control unit 70.

The control unit 70 controls operation of the motor 68, the hydraulic pump 66 and the actuators 28, 56, 58 and 60. The control unit 70 may be mounted on the trailer 14. The actuators are controlled via control valves 75 mounted on the base 16. The valves 75 provide proportional control, either manually at the valves 75 themselves or via the control unit 70. Proportional control of the actuators allows the speed and position of boom rotation to be infinitely adjustable within a practical operating range. Hydraulic lines (not shown) extend between the hydraulic pump 66 and the valves 75 and from the valves 75 to the various actuators to effect controlled operation of the boom assembly 22. Storage lockers 77 may also be mounted on the base 16 to store spare parts such as the roller assemblies 41, as well as fuel for the generator.

A plurality of leveling legs 72 are mounted on the base 16. The legs 72 are extendable and permit the mobile pole unit 10 to be leveled about pitch and roll axes when the mobile pole unit 10 is deployed on sloping or irregular ground. The leveling legs 72 may be deployed hydraulically or may alternately be deployable mechanically.

In operation, the mobile pole unit 10 is towed in its travel configuration to a location where an existing utility pole is to be replaced. The trailer 14 is maneuvered into position and the leveling legs 72 are deployed. Boom locks are unlocked to permit rotation of the boom segments 42. As shown in FIG. 1, the actuator 28 is used to pivot the boom assembly 22 (acting through terminal boom segment 44) about the axis 26 at the terminal end 24, and the actuator 58 is used to pivot the free boom segment 46 about the axis 52. As shown in FIG. 2, the actuator 56 is used to pivot the intermediate boom segment 48. As shown in FIG. 3, the various actuators 28, 56 and 58 are used in cooperation to adjust the height and vertical orientation of the utility pole 32, and the actuator 60 is used to orient the crossarm member 40 about the longitudinal axis 62 to accept the power lines 12. Operation of the mobile pole unit 10 may be performed wirelessly via a remote-control unit or the control unit 70 on the trailer 14. Wireless control affords greater safety and comfort to the operator, who can be at a safe distance from the mobile pole unit 10 in the event of an accident.

Mobile pole units, like the example described herein, can replace more expensive equipment, such as a mobile crane, to replace a utility pole which might otherwise require two cranes, one to hold the pole being replaced and the other to position the replacement pole in the previously occupied hole. Such mobile pole units may also be deployed and remain at a site where a downed pole is to be replaced until such time as assets become available to replace the downed pole. Use of such mobile pole units also allow immediate repairs to be made without permission from underground utilities because no excavation is required. This saves time, especially during a disaster, when it might be difficult to obtain clearance to dig. In this use, the mobile pole unit provides for uninterrupted power to users as the site waits its turn for repair, for example, in the aftermath of a storm when the resources of a utility company may be stretched to their limits by the extent of the damage. The ability to effect immediate temporary repair can save lives, livestock and property. Mobile pole units are not limited in use to power utilities, and may also be used to provide temporary communication, for example, deployed as a cell tower (base transceiver station) while a fixed cell tower is off-line for service or repair, or to alleviate a dead zone while a cell tower is being constructed. The mobile pole unit may be used to support and/or power overhead communication equipment including antennae, sets of transceivers, digital signal processors, control electronics, as well as a GPS receiver for timing.

U.S. and foreign published patent documents show a wide variety of mounting clamps and brackets for supporting overhead equipment such as crossarm members on utility poles as follows: U.S. Pat. Nos. 3,921,949; 4,466,506; 4,925,142; 5,076,449; 5,538,207; 6,142,434; 6,164,609; 6,520,462; 7,578,488; 7,814,825; 8,763,973; 9,010,703; 9,938,117; 10,385,534; and WO 88/08911.

A clevis fastener is a three-piece fastener system consisting of a clevis, a clevis pin, and a tang. The clevis is a U-shaped piece that has holes at the end of prongs or legs to accept the clevis pin. The clevis pin is similar to a bolt, but is only partially threaded or unthreaded with a cross-hole for a cotter pin. The tang is the piece that fits between the clevis and is held in place by the clevis pin. The combination of a simple clevis fitted with a pin is commonly called a shackle, although a clevis and pin is only one of the many forms a shackle may take.

Clevises are used in a wide variety of fasteners used in the farming equipment, sailboat rigging, as well as the automotive, aircraft and construction industries. They are also widely used to attach control surfaces and other accessories to servos in a model aircraft. As part of a fastener, a clevis provides a method of allowing rotation in some axes while restricting rotation in others.

Despite the prior art noted above, there is a need for an improved system and assembly for temporarily mounting overhead equipment on a utility pole without damaging the pole.

### SUMMARY OF EXAMPLE EMBODIMENTS

An object of at least one embodiment of the present invention is to provide a system and assembly for use in the system for temporarily mounting overhead equipment, such as crossarms, on a utility pole which system and assembly provide sufficient, repeatable, clamping force or pressure over time to avoid potentially unsafe slippage or shifting movement of the overhead equipment and without drilling or otherwise damaging the pole.

In carrying out the above object and other objects of at least one embodiment of the present invention, an assembly for temporarily mounting overhead equipment on a utility pole without damaging the pole is provided. The assembly includes an enclosure having first and second opposed multilayered parts. Each of the parts has a rigid substrate layer and a compressible, gripping layer overlying its substrate layer. The substrate layers of the parts are hingedly secured to one another by a hinge area which allows the parts to temporarily and repeatedly open and close in a closed configuration in which the parts at least partially define a passageway which extends completely therethrough. The gripping layers of the parts are configured to apply a clamping force at a desired location along the longitudinal length of the pole at opposite circumferential surfaces of the pole in the closed configuration. The assembly also includes a support member fixedly secured to one of the substrate layers and configured to support the overhead equipment. The clamping force is sufficient to maintain the assembly and the supported overhead equipment at the desired location during use of the assembly.

Each substrate layer may have a curved shape wherein each gripping layer may comprise heat shrink tubing having a curved shape along a length of the tubing. Each tubing may be configured to shrink circumferentially upon the application of a predetermined amount of heat to conform to the curved shape of its substrate layer.

Each gripping layer may be made of a dimensionally heat-unstable material configured to change dimensions upon the application of a predetermined amount of heat. The material may comprise cross-linked polymeric material, such as cross-linked polyolefin.

The hinge area may join the parts at first edges of the substrate layers.

The assembly may further comprise a closure device coupled to the substrate layers to facilitate temporary and repeated opening and closing of the enclosure. The closure device may include an adjustable tensioner configured to adjust the distance between second edges of the substrate layers opposite the first edges to adjust the clamping force of the gripping layers.

The tensioner may include a bell nut adjustably, threadedly mounted for linear movement on a threaded post of the closure device.

The assembly may further comprise a keeper pin configured to hold the post in a slot of a plate of the closure device.

The two layers of each of the parts may overlie and be in contact with one another.

The overhead equipment may comprise at least one temporary crossarm configured to support conductors.

The utility pole may be a temporary utility pole made from fiber-reinforced composite materials.

Each substrate layer may be a metal layer having a curved shape.

The support member may be fused or welded to one of the substrate layers.

Each of the parts may be formed as a unitary part.

The support member may comprise either a metal channel or a bent metal plate.

Still further in carrying out the above object and other objects of at least one embodiment of the present invention, a system for temporarily mounting overhead equipment on a utility pole without damaging the pole is provided. The system includes upper and lower enclosures each as claimed in claim 1 and a support member fixedly secured to one of the substrate layers of each of the enclosures. The clamping forces applied by the gripping layers of the enclosures are sufficient to maintain the system and the supported overhead equipment at the desired locations along the longitudinal length of the pole.

The system may further comprise a stop assembly configured to be positioned immediately adjacent the lower enclosure to prevent downward movement of the lower enclosure under the force of gravity along the longitudinal length of the pole.

The stop assembly may comprise an enclosure as claimed in claim 1.

### BRIEF DESCRIPTION OF THE DRAWINGS

FIGS. 1-3 are side schematic view of a prior art mobile pole unit in different intermediate stages of positioning a utility pole from a make-up position (not shown), at which various overhead equipment, such as one or more crossarms and brackets, is installed, to a final use position (not shown);

FIG. 4 is a perspective, schematic view, partially broken away, of a prior art assembly for temporarily mounting overhead equipment such as a crossarm member to the utility pole of FIGS. 1-3;

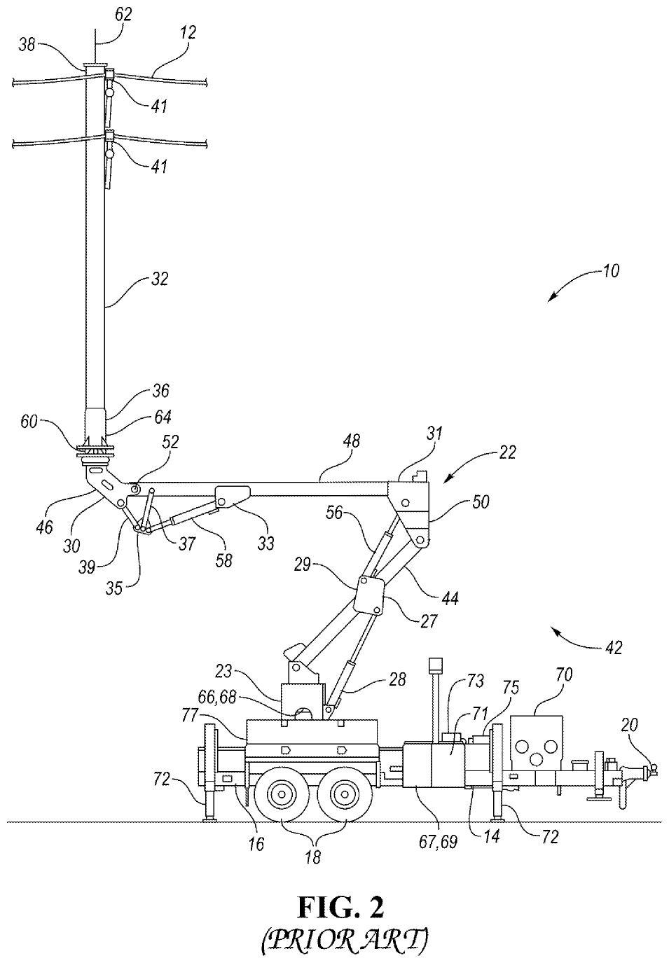

FIG. 5 is a side schematic view, partially broken away, of a system for temporarily mounting overhead equipment on the pole of FIGS. 1-4 and constructed in accordance with at least one embodiment of the present invention;

FIG. 6 is a view similar to the view of FIG. 5, but showing a typical support member for a crossarm member;

FIG. 7 is a perspective schematic view, partially broken away, of the system of FIGS. 5 and 6 with a crossarm member supported by the system; and

FIG. 8 is a schematic end view of an assembly of the system of FIGS. 5-7 in which various radially extending arrows represent a clamping force and a single vertically extending arrow represents a tension force which opposes a vertical load of the system and supported overhead equipment on the pole.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As used in this application, the term “substrate” or “substrate layer” refers to any rigid single or multi-layer component having a surface to which a compressible gripping layer is or can be applied such as by heat shrinking. The gripping layer may be made of polymers and other plastics, as well as composite materials. Furthermore, the shape of the substrate and, particularly, the surface to be covered can be any part of an assembly or device manufactured by any of various methods, such as, without limitation, conventional metal bar rolling, or otherwise fabricated. The support member may be a metal plate bent to form a channel or a bent metal plate.

The term “overlies” and cognate terms such as “overlying” and the like when referring to the relationship of one or a first, superjacent layer relative to another or a second, subjacent layer, means that the first layer partially or completely lies over the second layer. The first, superjacent layer overlying the second, subjacent layer may or may not be in contact with the subjacent layer; one or more additional layers may be positioned between respective first and second, or superjacent and subjacent layers.

The term “heat-shrink tubing” (or, commonly, heat shrink or heatshrink) is a shrinkable plastic tube often used to insulate wires, providing abrasion resistance and environmental protection for stranded and solid wire conductors, connections, joints and terminals in electrical work. It can also be used to repair the insulation on wires or to bundle them together, to protect wires or small parts from minor abrasion, and to create cable entry seals, offering environmental sealing protection. Heat-shrink tubing may be made of polyolefin, which shrinks radially (but not longitudinally) when heated, to between one-half and one-sixth of its diameter.

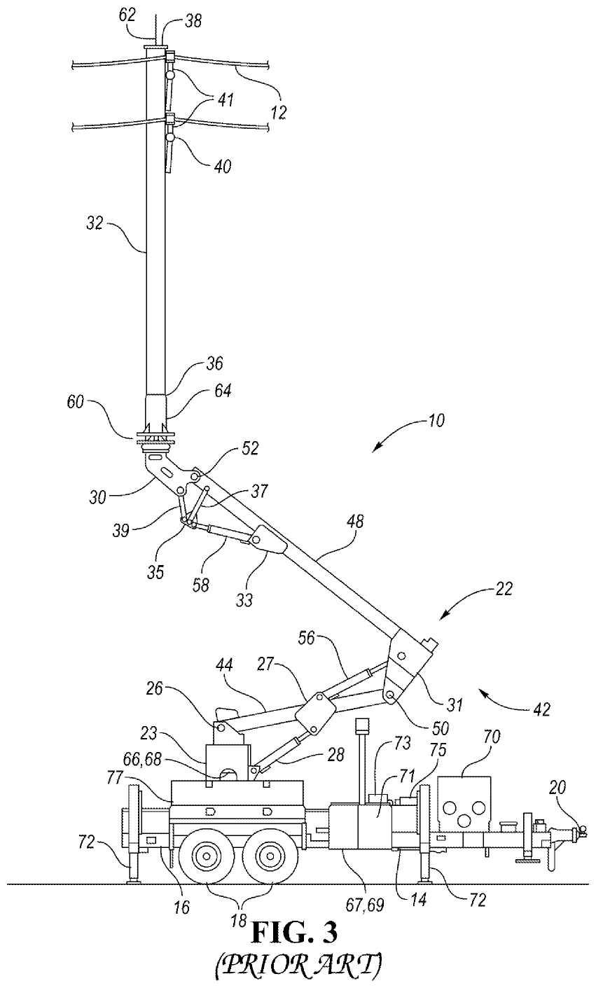

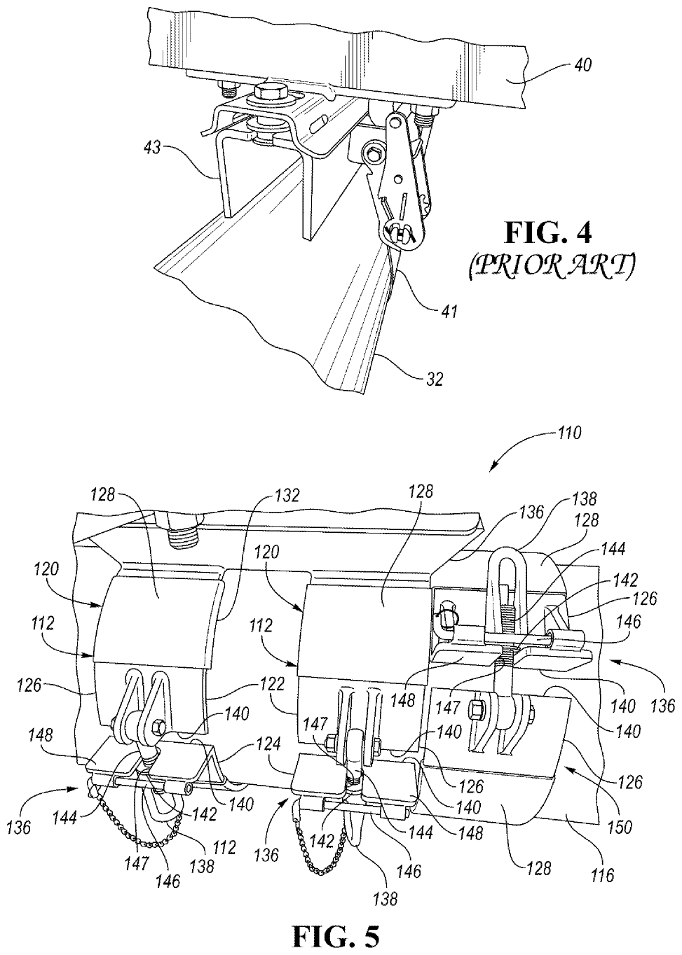

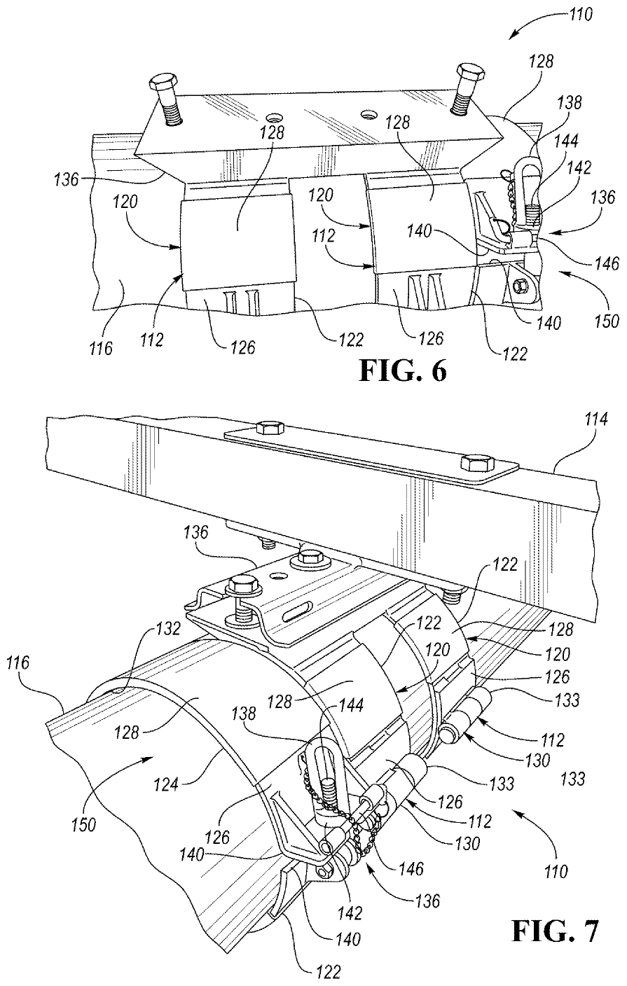

Referring now to drawing FIGS. 5-8, there is illustrated a system, generally indicated at 110, and assemblies, generally indicated at 112, for use therein for temporarily and repeatedly mounting overhead equipment such as a crossarm 114 on a utility pole 116 without damaging the pole 116.

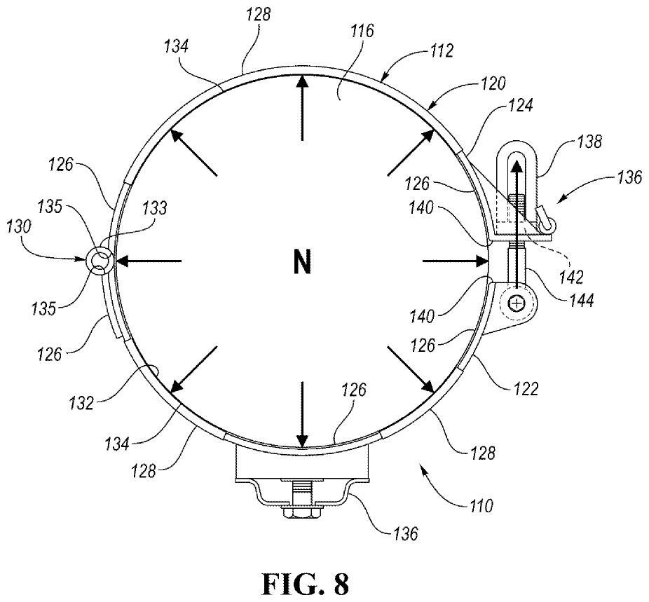

Each assembly 112 generally typically comprises an enclosure, generally indicated at 120, having a first and second opposed, unitary multilayered parts 122 and 124. Each of the parts 122 and 124 has a rigid substrate layer 126 and a compressible, gripping layer 128 overlying its substrate layer 126. The parts 122 and 124 are hingedly secured to one another by a hinge area, generally indicated at 130, which allows the two parts 122 and 124 to temporarily and repeatedly open and close in a closed configuration (as shown in FIGS. 5-8) in which the parts 122 and 124 at least partially define a passageway 132 which extends completely therethrough. The gripping layers 128 of the parts 122 and 124 are configured to apply a clamping force at a desired location along the longitudinal length of the pole 116 at opposite circumferential surfaces 134 of the pole 116 in the closed configuration as shown in FIG. 8.

Each assembly 112 also includes a support member 136 fixedly secured to one of the substrate layers 126 and configured to support the overhead equipment 114. The clamping force is sufficient to maintain the assembly 112 and the supported overhead equipment 114 at the desired location on the pole 116 during use of the assembly 112.

Each substrate layer 126 typically has a curved shape. Each gripping layer 128 typically comprises heat shrink tubing having a curved shape along a length of the tubing. The tubing is configured to shrink upon the application of a predetermined amount of heat to conform to the curved shape of its substrate layer 126.

Each gripping layer 128 is made of a dimensionally heat-unstable material configured to change dimensions upon the application of a predetermined amount of heat. The material typically comprises a cross-linked polymeric material such as polyolefin. However, it is to be understood that other types of polymeric material may be used, such as PVC. Aside from these two materials, one can also use heat shrink material made of rubber elastomers, PVDF, Silicone, PTFE, FEP and Viton.

The hinge area 130 typically includes a hinge 133 which joins the parts 122 and 124 at first edges 135 of the substrate layers 126.

Each assembly 112 typically also comprises a closure device or latch, generally indicated at 136, coupled to the substrate layers 126 to facilitate temporary and repeated opening and closing of the enclosure 120. The closure device 136 includes an adjustable tensioner 138 configured to adjust the distance between second edges 140 of the substrate layers 126 opposite the first edges 135 to adjust the clamping force of the gripping layers 128 in the closed configuration without damaging the pole 116. The tensioner 138 includes a bell nut 142 adjustably, threadedly mounted for linear movement on a threaded post 144 of the closure device 136. The tensioner 138 may be referred to as a head tensioner and is used to vary the clamping force applied by the gripping layers 128 on the pole 116.

Each assembly 112 may further comprise a keeper pin 146 configured to hold the support post 144 in a slot 147 formed in a plate 148 of the closure device 136. The plate 148 is fixedly secured to one of the substrate layers 126 such as by welding.

Typically, the two layers 126 and 128 overlie and are in contact with one another. However, it is to be understood the other layers (not shown) may be disposed between the two layers 126 and 128.

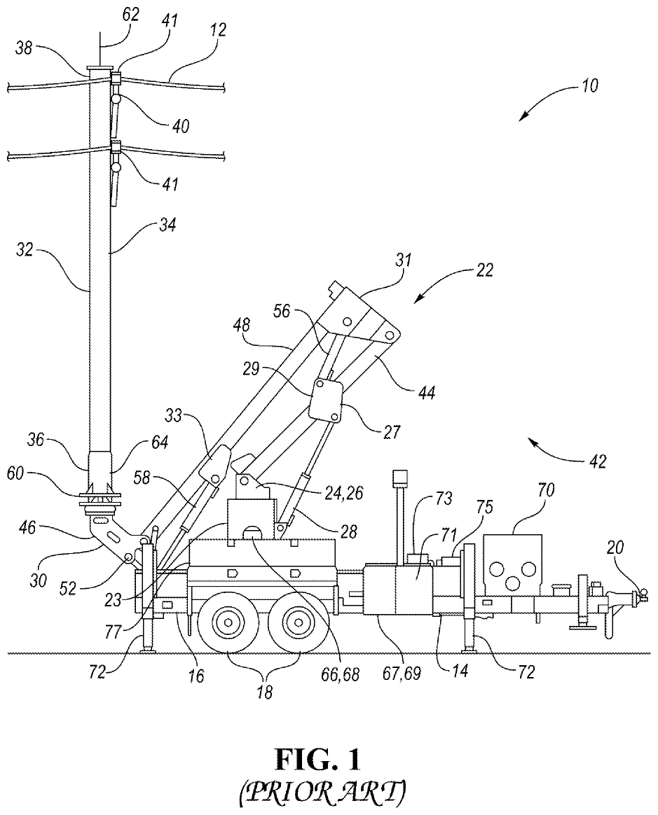

The overhead equipment may comprise one or more temporary crossarms 114 configured to support conductors or wires such as shown in FIGS. 1-3. However, it is to be understood that other well-known overhead electrical and/or communication equipment can be mounted by the system 110 of the present invention to the utility pole 116. The utility pole 116 may be a temporary utility pole made from fiber-reinforced composite materials or other materials such as wood, metal, etc.

Each substrate layer 126 may be a metal layer having a curved shape. The metal may be stainless steel. The support member 136 may be fused or welded to one of the substrate layers 126. The support member 136 may comprise either a metal channel or a bent metal plate as best shown in FIG. 8.

The system 110 is used for temporarily mounting overhead equipment on the utility pole 116 without damaging the pole 116. Typically, the system 110 comprises upper and lower enclosures 120 as shown in FIGS. 5-7 and the support member 136 fixedly secured to one of the substrate layers 126 of each of the enclosures 120. The clamping forces applied by the gripping layers 122 are sufficient to maintain the system 110 and the supported overhead equipment at the desired locations along the longitudinal length of the pole 116 during use of the system 110.

The system 110 may further comprise a stop assembly, generally indicated at 150, configured to be positioned immediately adjacent the lower enclosure 120 to prevent downward sliding or shifting movement of the lower enclosure 120 under the force of gravity along the longitudinal length of the pole 116, typically if adjustment of either the upper or lower enclosures 120 needs to be done. The stop assembly 150 typically comprises a enclosure 112 substantially identical to the upper and lower enclosures 112. The other components of the stop assembly 112 are substantially identical to the components of the assemblies 112 and, consequently, have the same reference numbers.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An assembly for temporarily mounting overhead equipment on a utility pole without damaging the pole, the assembly comprising:
an enclosure having first and second opposed multilayered parts, each of the parts having a rigid substrate layer and a compressible, gripping layer overlying its substrate layer, the substrate layers of the parts being hingedly secured to one another by a hinge area which allows the parts to temporarily and repeatedly open and close in a closed configuration in which the parts at least partially define a passageway which extends completely therethrough, wherein the gripping layers of the parts are configured to apply a clamping force at a desired location along the longitudinal length of the pole at opposite circumferential surfaces of the pole in the closed configuration; and
a support member fixedly secured to one of the substrate layers and configured to support the overhead equipment, the clamping force being sufficient to maintain the assembly and the supported overhead equipment at the desired location during use of the assembly.

2. The assembly as claimed in claim 1, wherein each substrate layer has a curved shape and wherein each gripping layer comprises heat shrink tubing having a curved shape along a length of the tubing and wherein each tubing is configured to shrink circumferentially upon the application of a predetermined amount of heat to conform to the curved shape of its substrate layer.

3. The assembly as claimed in claim 1, wherein each gripping layer is made of a dimensionally heat-unstable material configured to change dimensions upon the application of a predetermined amount of heat.

4. The assembly as claimed in claim 3, wherein the material comprises cross-linked polymeric material.

5. The assembly as claimed in claim 4, wherein the material comprises cross-linked polyolefin.

6. The assembly as claimed in claim 1, wherein the hinge area joins the parts at first edges of the substrate layers.

7. The assembly as claimed in claim 6, further comprising a closure device coupled to the substrate layers of the parts to facilitate temporary and repeated opening and closing of the enclosure.

8. The assembly as claimed in claim 7, wherein the closure device includes an adjustable tensioner configured to adjust the distance between second edges of the substrate layers opposite the first edges to adjust the clamping force of the gripping layers.

9. The assembly as claimed in claim 8, wherein the tensioner includes a bell nut adjustably threadedly mounted for linear movement on a threaded post of the closure device.

10. The assembly as claimed in claim 9, further comprising a keeper pin configured to hold the post in a slot of a plate of the closure device.

11. The assembly as claimed in claim 1, wherein the two layers of each of the parts overlie and are in contact with one another.

12. The assembly as claimed in claim 1, wherein the overhead equipment comprises at least one temporary crossarm configured to support conductors.

13. The assembly as claimed in claim 1, wherein the utility pole is a temporary utility pole made from fiber-reinforced composite materials.

14. The assembly as claimed in claim 2, wherein each substrate layer is a metal layer.

15. The assembly as claimed in claim 14, wherein the support member is fused or welded to one of the substrate layers.

16. The assembly as claimed in claim 1, wherein each of the parts is formed as a unitary part.

17. The assembly as claimed in claim 15, wherein the support member comprises either a metal channel or a bent metal plate.

18. A system for temporarily mounting overhead equipment on a utility pole without damaging the pole, the system comprising upper and lower enclosures each as claimed in claim 1 and a support member fixedly secured to one of the substrate layers of each of the enclosures wherein the clamping forces applied by the gripping layers of the enclosures are sufficient to maintain the system and the supported overhead equipment at the desired locations along the longitudinal length of the pole.

19. The system as claimed in claim 18, further comprising a stop assembly configured to be positioned immediately adjacent the lower hollow enclosure to prevent downward movement of the lower enclosure under the force of gravity along the longitudinal length of the pole.

20. The system as claimed in claim 19, wherein the stop assembly comprises an enclosure as claimed in claim 1.
